(19) United States
(12) Patent Application Publication
(10) Pub. No.: US 2010/0029312 A1
(43) Pub. Date: Feb. 4, 2010

(54) Mobile originated internet relay chat

(76) Inventors: Richard A. Smith, Annapolis, MD (US); Orville A. Pike, Annapolis, MD (US); Johanna Wilson, Annapolis, MD (US)

Correspondence Address: LAWRENCE HARBIN;HARBIN & HEIN PLLC, 500 9TH STREET SE, WASHINGTON, DC, 20003, US

(21) Appl. No.: 12/461,909

(22) Filed: Aug. 27, 2009

Related U.S. Application Data
(63) Continuation of application No. 09/525,926, filed on Mar. 15, 2000, now abandoned.

(51) Int. Cl. H04W 4/12

(52) U.S. Cl. 455/466

(57) ABSTRACT

Internet Relay Chat is provided for mobile devices utilizing a mobile chat proxy server. The server exchanges message objects with a wireless Internet gateway using an IRC protocol. The server maintains a real-time proxy connection to a conventional IRC server for each mobile device. The proxy server interprets messages and determines whether to forward them to the conventional IRC server. The proxy server utilizes an RMI interface between the mobile chat proxy server and the wireless Internet gateway for sending messages to chat group participants. The proxy server also provides such enhancements as notification and/or summons commands, and allows mobile users to chat simultaneously. An SMSC forwards messages to the mobile chat proxy server and proxy server configures and validates users. After validating a mobile user, the mobile chat proxy server forwards IRC traffic from the mobile device to the conventional IRC server.

### BACKGROUND OF THE INVENTION

1. Field of the Invention

The present invention relates generally to wireless telecommunication, Instant Messaging, and Internet chat applications and systems.

2. Background of Related Art

Internet Relay Chat (IRC), ICQ, and Instant Messaging are digital techniques allowing users of computers to communicate textual messages to one another in a real-time environment.

IRC (“Internet Relay Chat”) is a system for chatting that involves a set of rules and conventions and client/server software. Unlike older chat systems, IRC is not limited to just two participants. Conventionally, an IRC client can be downloaded to a user's computer (e.g., PC or Palm Pilot™).

IRC is based on a client-server model, or network, as shown in FIG. 18. A user must connect to an IRC server in an IRC network to start or join an IRC chat group. As shown in FIG. 18, an IRC network is a collection of servers linked together. When you log onto an IRC network, you are connecting to one of the servers on that network. All servers on the IRC network share and have access to the same information. Thus, each server knows who is on the network, which chat rooms the users are currently in, and which servers the users are using as well.

Using IRC, a new chat group can be started, or an existing chat group can be joined. There is a protocol for discovering existing chat groups and their members. Perhaps the most common IRC networks are IRCnet (mostly European), Efnet (mostly North American), Undernet, and Dalnet. Popular IRC clients include mIRC for Windows, IRCle for MacOS, and irc2 (the original client) for UNIX-based operating systems.

The IRC protocol uses Transmission Control Protocol (TCP). TCP is a connection-oriented protocol used along with the Internet Protocol (IP) to send data in the form of message units between computers over the Internet. While IP takes care of handling the actual delivery of the data, TCP takes care of keeping track of the individual units of data (called packets) that a message is divided into for efficient routing through the Internet.

ICQ (“I Seek You”) is a program you can download that will let you know when friends and contacts are also online on the Internet, page them, and chat with them. In order to get maximum benefit from ICQ, both parties must have downloaded the ICQ program and have received a user identification number (UIN). The download and registration procedure are simple and enable you to send messages, files (single, multiple or whole directories), and URLs directly to your friends' desktops. In addition, you can initiate an IRC-style chat session or voice and video-voice connection and play games with other ICQ members that you are in touch with. Your contact is signaled of an incoming event as soon as it arrives and has immediate access to it.

Instant Messaging is a type of communications service that enables you to create a private chat room with another individual. Typically, an instant messaging system alerts you whenever somebody on your private list is online. You can then initiate a chat session with that particular individual.

Currently, there are several competing instant messaging systems, and no standard. Therefore, anyone a computer user would want to send an instant message to must use the same instant messaging system that the sender uses.

Conventionally, IRC, ICQ, and Instant Messaging are generally limited for use by users having a personal computer (PC) attached to the Internet.

More recently, there have been general announcements by some manufacturers of plans to develop Instant Messaging for use in a mobile handset. However, the proposed solutions apparently utilize new, vendor-specific handsets (e.g., from MOTOROLA) and a proprietary chat protocol (e.g., AOL's Instant Messenger). Thus, a user desiring to utilize such a new service must by a new mobile handset from the particular vendor including functionality to operate the necessary proprietary chat protocol.

There have also been announcements of plans to develop browser-specific software for chat. However, such solutions require a mobile handset manufacturer to load special software on the handsets, which is not a procedure that can be performed easily or properly by many consumers or carriers.

Conventional approaches or plans allowing implementation of Instant Messaging or other chat functionality in mobile handsets (e.g., wireless telephones using analog, TDMA or CDMA RF technology) do not provide for chat participation by older, currently existing mobile telephones (i.e., “mobile terminated telephones”). Moreover, the conventional approaches do not allow standard mobile telephones (i.e., not having browser-specific chat software or other proprietary software loaded) to originate a chat message.

There is a need for a technique and apparatus which allows standard mobile telephones to participate in Internet chat groups such as those provided by Instant Messaging, Internet Relay Chat (IRC), or ICQ.

### SUMMARY OF THE INVENTION

In accordance with the principles of the present invention, a device and method for providing access to a channel of an Internet Relay Chat group to a mobile device comprises placing a mobile chat proxy server in a communication path between a standard Internet Relay Chat server and a wireless gateway server supporting the mobile device. The mobile chat proxy server forwards chat commands from the mobile device to the standard Internet Relay Chat server.

Another device and method of handling chat group commands between a mobile device and a chat group server in accordance with another aspect of the present invention comprises examining non-standard chat group commands transmitted by a mobile device. The standard chat group commands are forwarded based on the non-standard chat group commands to the chat group server.

### BRIEF DESCRIPTION OF THE DRAWINGS

Features and advantages of the present invention will become apparent to those skilled in the art from the following description with reference to the drawings, in which:

FIG. 1 shows an exemplary chat system using a proxy chat server between a standard IRC server and a service provider gateway such as a wireless internet gateway, in accordance with the principles of the present invention.

FIG. 2 shows exemplary types of interfaces used to interconnect the various devices shown in FIG. 1.

FIG. 3 shows how the invention is able to support various types of clients for Chat services. The software allows other applications, such as web servers and WAP Servers, to enroll participants in Chat groups.

FIG. 4 shows an overview of the communications between the user of the mobile device, the short messaging system controller, the mobile chat proxy server, the database, the conventional IRC server, and IRC clients participating in a chat group, in accordance with the principles of the present invention.

FIG. 5 shows an exemplary top level sequence of events in an initial mobile originated connection using a mobile chat proxy server, in accordance with the principles of the present invention.

FIG. 6 shows an exemplary top level sequence of events in a mobile originated conversation using a mobile chat proxy server, in accordance with the principles of the present invention.

FIG. 7 shows an exemplary top level sequence of events for an improperly formatted mobile originated message using a mobile chat proxy server, in accordance with the principles of the present invention.

FIG. 8 shows an exemplary processing of a message queue of a mobile chat proxy server, in accordance with the principles of the present invention.

FIG. 9 shows an exemplary sequence of events in an Applet-based conversation, in accordance with the principles of the present invention.

FIG. 10 illustrates the components of an IRC chat group solution allowing IRC-enabled mobile handsets to participate in IRC chat groups using an Interworking Function (IWF) connection (in place of the SMPP connection shown in FIG. 1), in accordance with the principles of the present invention.

FIG. 11 shows an initial connection to the IRC server shown in FIG. 10, in accordance with the principles of the present invention.

FIG. 12 is a detailed process flow showing the validation of the mobile user in the mobile chat system shown in FIG. 11.

FIG. 13 shows an update of the provisioning database in the system of FIG. 10, in accordance with the principles of the present invention.

FIG. 14 shows an exemplary process of an IRC “Notice” command, in accordance with the principles of the present invention.

FIG. 15 shows an exemplary IRC “Notify” command having special properties for an SMS, in accordance with the principles of the present invention.

FIG. 16 shows a special “Ghost” command to enable a user to monitor an IRC chat group (or channel) via the short message service (SMS) without maintaining a connection to the conventional IRC server, in accordance with the principles of the present invention.

FIG. 17 shows the implementation of a special IRC “Invite” command to provide the mobile user with the opportunity to use SMS to extend chat invitations to other mobile users, in accordance with the principles of the present invention.

FIG. 18 shows a conventional Internet Relay Chat (IRC) group based on a client-server model, or network, wherein a user connects to an IRC server in an IRC network to start or join an IRC chat group (channel).

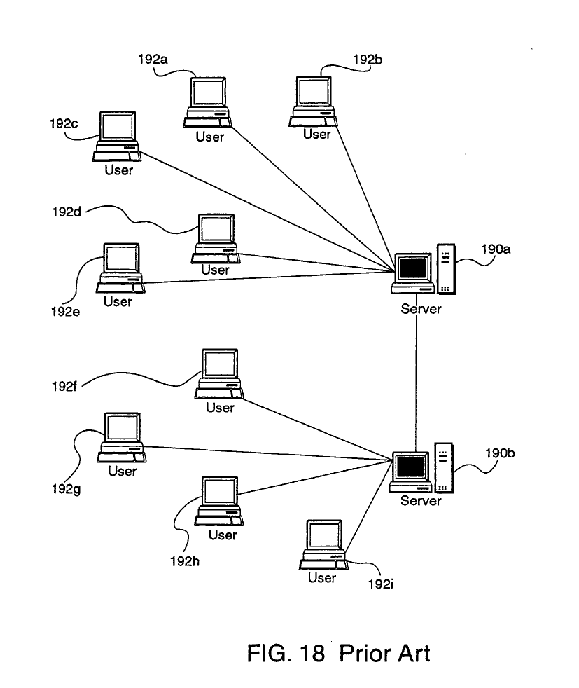

### DETAILED DESCRIPTION OF PREFERRED EMBODIMENTS

The present invention allows mobile and other devices to participate in Internet Relay Chat (IRC) groups, ICQ, and/or Instant Messenger groups using open standards (e.g., IRC). The solution allows standard mobile originated, WAP, and HDML handsets to both read (e.g., “lurk”) and to participate in chat groups, and allows standard mobile terminated handsets and pagers to read (i.e., “lurk”) in chat groups. It also allows a user to distribute a Chat session across two mobile devices: one for posting messages (e.g. a Palm VII) and one for receiving messages (e.g., a mobile-terminated phone).

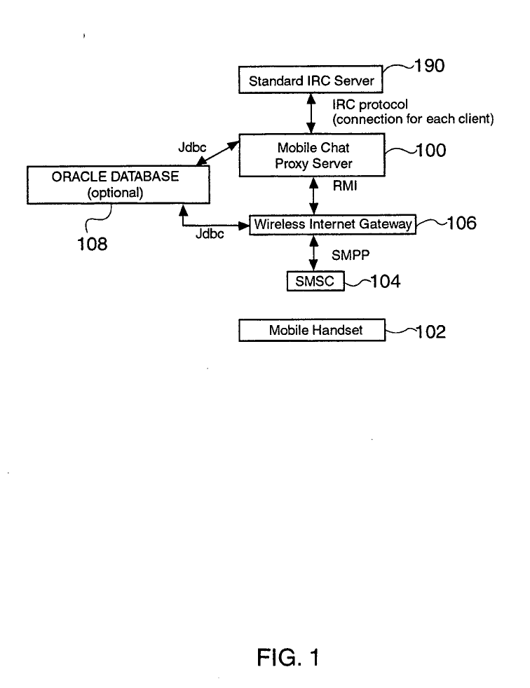

FIG. 1 shows an exemplary chat system using a proxy chat server 100 between a standard IRC server 190 and a service provider gateway such as a wireless internet gateway 106, in accordance with the principles of the present invention.

In particular, FIG. 1 shows an architecture using a ‘best of breed’ component-based approach, utilizing a third party standard IRC server 190, a wireless Internet gateway 106, and an (optional) Oracle database 108.

An appropriate wireless Internet gateway 106 is commercially available from TeleCommunication Systems, Inc. in Annapolis, Md. The wireless internet gateway 106 is accessed by a subscriber mobile handset 102 through a servicing short message servicing center (SMSC) 104.

Importantly, as shown in FIG. 1, a mobile chat (MOChat™) proxy server 100 is provided between the standard IRC server 190 and the relevant wireless internet gateway 106. The mobile chat proxy server 100 is also referred to as a “mobile originated chat server”, and/or under its trademark name of a “MOChat™ proxy server”. The mobile chat proxy server 100 integrates the components shown in FIG. 1 by serving as a proxy between the wireless Internet gateway 106 and the standard IRC server 190.

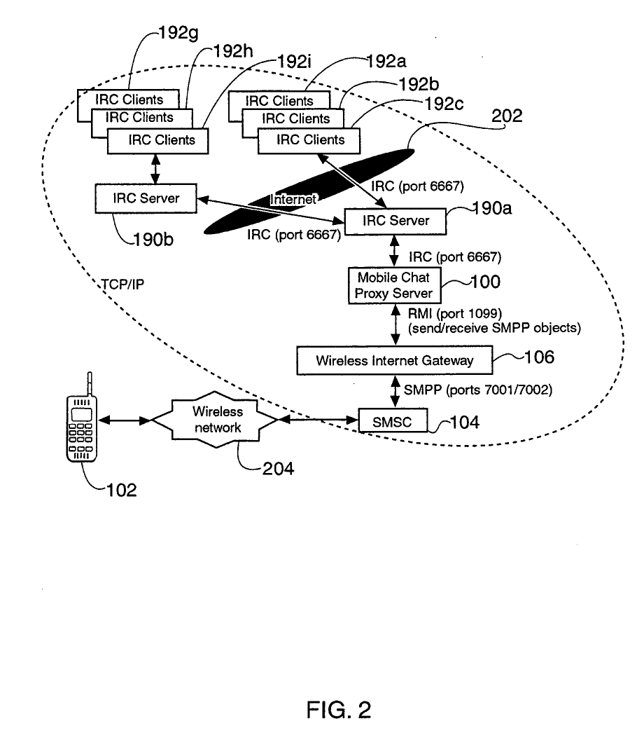

FIG. 2 shows exemplary types of interfaces used to interconnect the various devices shown in FIG. 1.

In particular, FIG. 2 shows the insertion of a mobile chat proxy server 100 between a conventional IRC server 190a and a wireless Internet gateway 106. Thus, the solution utilizes a two-tiered IRC server approach-one conventional (IRC server 190a), and an inventive proxy server (MO Chat™ server 100), to allow wireless device (e.g., mobile handset 102) users to read and/or participate in chat groups. Note the presence of the Internet 202 and wireless network 204.

In FIG. 2, all IRC communications are according to IRC request for comments (RFC) 1459. Moreover, as shown, all SMPP communications are according to the v3.3 specification published by Aldiscon. SMPP v3.4 can also be supported.

Communication between the mobile chat proxy server 100 and the wireless Internet gateway 106 uses the Java Remote Invocation Protocol (RMI). RMI is a distributed computing protocol that allows separate programs, potentially on separate computers, to exchange software objects. Using a special implementation of this protocol, a very powerful and flexible mechanism is provided for external applications (such as the mobile chat proxy server 100) to interact in an object-oriented fashion with the SMSC 104 and wireless handsets 102.

Any conventional IRC server can be used as the standard IRC server 190a shown in the FIGS. 1 and 2. Although some IRC servers can be modified for special needs, a strength of the principles of the present invention is that the use of the mobile chat proxy server 100 allows chat room participation to conform to open standards. Exemplary RFC and IRC architecture can be found at http://www.ietf.org/rfc/rfc1459.txt.

After binding to the wireless Internet gateway 106, the mobile chat proxy server 100 exchanges message objects with the wireless Internet gateway 106. The messages are of various types, including text messages to and from wireless devices such as the wireless mobile handset 102 shown in FIG. 2. By binding to the wireless Internet gateway 106, the mobile chat proxy server 100 can receive messages from mobile (i.e., wireless) devices, and/or send messages to other mobile (i.e., wireless) devices, providing the basis for chat group participation by mobile devices.

The interface to the conventional IRC server 190a from the mobile chat proxy server 100 uses standard IRC protocol. Thus, the present invention allows the continued use of existing IRC servers 190a, with the added functionality of allowing mobile users to participate in chat groups by simply adding a mobile chat proxy server 100 as an interface device to a wireless network.

The mobile chat proxy server 100 maintains a real-time proxy connection to the conventional IRC server 190a for each mobile device, e.g., mobile handset 102. From the perspective of the IRC server 190a, connections through the mobile chat proxy server 100 appear as regular (e.g., standard conforming) IRC clients. Accordingly, chat messages from the conventional IRC server 190a are sent to a connection in the mobile chat proxy server 100, which are in turn forwarded through the wireless Internet gateway 106 to the mobile devices, e.g., mobile handset 102.

In operation, the mobile chat proxy server 100 interprets chat messages from mobile devices, and determines if and how they should be forwarded to the conventional IRC server 190a.

For example, a message with content “#ABC” will cause the mobile chat proxy server 100 to send a command to the conventional IRC server 190a that will enroll the relevant device in the #ABC chat group. At that point, the relevant mobile user will be participating in the #ABC chat group, and all other group members, Internet based or otherwise, will be aware of the new participant.

Once registered in a chat group, any non-command based messages from a mobile device will be directly forwarded by the mobile chat proxy server 100 to the conventional IRC server 190a, where they will be broadcast to all chat group members. Messages from other members of the chat group will be sent from the conventional IRC server 190a to a connection in the mobile chat proxy server 100, then to the wireless Internet gateway 106, and then finally to the mobile handset 102.

The interface between the mobile chat proxy server 100 and the wireless Internet gateway (“gateway”) 106 is unique in that the gateway acts as wireless messaging middleware in which the details of reliable transmission to the wireless destination (e.g., mobile handset 102) are hidden from the chat group clients.

In particular, using Java's RMI protocol between the mobile chat proxy server 100 and the wireless Internet gateway 106, mobile chat group clients can directly access the Queue and SMPP objects within the wireless Internet gateway 106. Most simply, mobile chat group clients can create a message object and insert it into a remote queue of the wireless Internet gateway 106. Upon doing so, the wireless Internet gateway 106 will synchronously return a unique message tracking number. The remote queue can later be queried to determine the status of delivery.

In this exemplary scenario, details regarding message delivery can be completely hidden from the mobile chat group client; whether it is delivered by SMPP, TNPP, or the Web does not matter. The mobile chat proxy server 100 utilizes the RMI interface between the mobile chat proxy server 100 and the wireless Internet gateway 106 for sending messages to the chat group participants using mobile handsets.

The mobile chat proxy server 100 also utilizes the remote SMPP interface of the wireless Internet gateway 106, which communicates with the short messaging system controller (SMSC) 104. A suitable SMSC is commercially available from TeleCommunication Systems Inc. in Annapolis, Md.

The remote SMPP interface allows mobile chat group clients to directly interact with the SMPP messaging traffic of the SMSC 104, and thus allows a mobile chat group client to send and receive SMPP message objects of various types. In the disclosed embodiment, the SMPP message types are object-oriented.

In the disclosed embodiment, an object or module named “MobileReceiver” binds to the SMPP interface of the wireless Internet gateway 106 to allow reception of mobile chat group messages. Similarly, an object or module named “MobileSender” utilizes the remote queue to allow delivery of chat group messages to wireless devices (e.g., mobile handsets) serviced by the wireless network 204.

The mobile chat proxy server 100 is able to receive SMPP messages through the remote SMPP interface from the wireless Internet gateway 106 that represent mobile originated messages from the mobile device (e.g., mobile handset 102). The mobile chat proxy server 100 is therefore able to receive chat group messages from the mobile handset 102, interpret them in the IRC context, and send appropriate standardized IRC commands to the conventional IRC server 190a.

This solution has applicability beyond regular chat groups. For instance, to subscribe to various pre-defined chat groups (i.e., Information Cafe™ chat groups), only a predefined application in the mobile chat proxy server 100 may publish messages to these chat groups. Information Café™ chat groups can be created according to the type of information that will be published by the predefined application. For example, Information Café™ chat groups might exist for hourly news updates.

Use of an IRC proxy gateway in accordance with the principles of the present invention provides front-end services to a standard IRC server. For example. the IRC proxy gateway (i.e., mobile chat proxy server 100) can provide user validation, special short messaging system (SMS) handling for certain commands (e.g., Notify, Notice, Mode, Ghost, etc.), and/or customer-requested metrics. Moreover, a mobile chat proxy server 100 provides mobile enhancements to standard IRC commands. The mobile chat proxy server 100 can utilize any appropriate operating system, e.g., UNIX or WINDOWS NT.

A core notion of the present invention is the placement of a proxy between an otherwise conventional Internet Relay Chat (IRC) server and the wireless components of a mobile system. Moreover, features such as summoning other mobile users to join a mobile originated chat group, and/or ghosting a chat session remain the same.

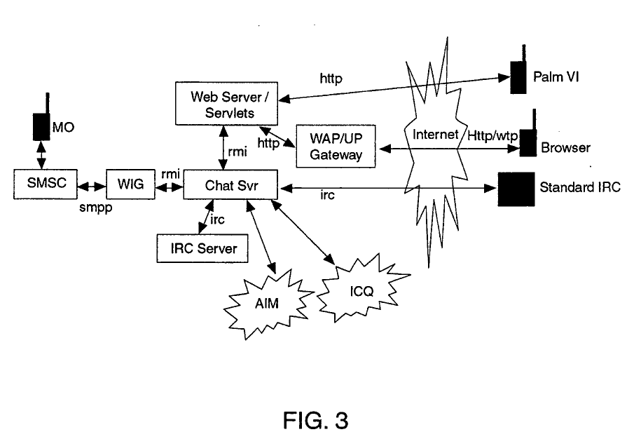

FIG. 3 shows how the Chat Server integrates with other Server Software to provide Chatting capabilities to a greater number of mobile devices, including PALM VII and phone browser clients. The Chat Server offers an open software interface based on the Remote Method Invocation protocol. Using this interface, TCS has enabled Palm VII, WML, and HDML handset browsers to interact with the Chat Server. These three devices interact with the Chat Server by way of a Web Server with Java Servlet support. The phone browsers must also communicate through an Unwired Planet Server or WAP Server for HDML and WML browsers, respectively. The devices interact with a Servlet running on the Web Server. Using the Chat Server's RMI connection, the Servlet is able to pass chat messages between the Chat Server and the browser device. The result is that all of these devices can participate in the same chat groups and can have awareness of one another.

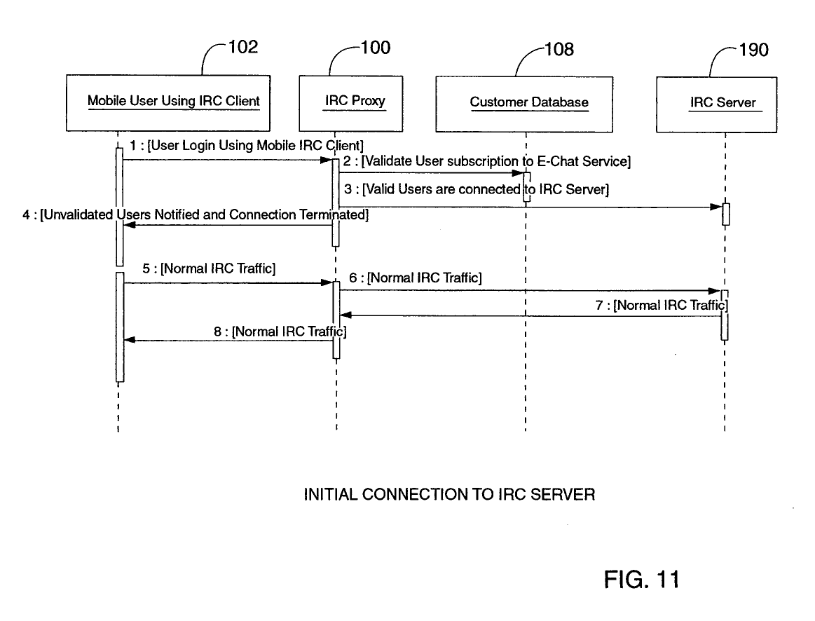

FIG. 3 also illustrates how standard IRC enabled clients can interact directly with the Chat Server. The Chat Server is thereby able to provide consistent user authentication and special services to the IRC clients. IRC clients are available for most major computer systems as well as small devices such as Palm Pilots and Windows CE devices. It is also possible to run IRC client software natively on mobile phones. In which case, as a standard IRC client, the phone directly interacts with the Chat Server. FIG. 11 illustrates this scenario, which is described in greater detail later in this document.

Finally, FIG. 3 also shows integration between the Chat Server and external Chat Services such as AOL's Instant Messenger (AIM) and ICQ. The Chat Server is designed to accommodate gateway services that translate between these proprietary systems and IRC. Since the Chat Server is the central messaging hub, multiple devices from multiple services can all intercommunicate and be aware of one another.

When integrating with Mobile Originated handsets through the Wireless Internet Gateway and SMSC, users may issue special chat commands. In accordance with the principles of the present invention, rather than requiring upgrading of an existing IRC server base, a mobile chat proxy server 100 can be interjected between the participating client and the relevant conventional IRC server 190. In this way, the mobile chat proxy server 100 intercepts the special commands, interprets the special commands, and either acts on the special commands or forwards the special commands to the conventional IRC server 190.

For example, a chat group user may issue the command “alias*Fred”. This special command will be intercepted by the mobile chat proxy server 100, and interpreted to cause the mobile chat proxy server 100 to send an appropriate command to the conventional IRC server 190 to change the alias for the relevant mobile user to ‘Fred’.

As another example, the “summon” command may be used to allow mobile users to request other mobile users to join a particular chat group. The “summon” command is processed by the mobile chat proxy server 100 and acted on itself, without forwarding the same to the standard IRC server 190.

The specifics of the actual command strings to be entered for interpretation by the mobile chat proxy server 100 (e.g., ‘alias’, ‘summon’, etc.) may be configured by the administrator.

System requirements and analysis of the exemplary mobile chat proxy server 100 follow, together with a more detailed description of the relationship between the mobile chat proxy server 100 and the conventional IRC Server 190.

The mobile chat proxy server 100 facilitates 2-way text conversations between users of cell phones 102, web browser users 330, and/or other chat group users, e.g., Instant Messaging service users.

Several possible scenarios are accommodated by the mobile chat proxy server 100, in accordance with the principles of the present invention.

### Scenario A: Peer to Peer User Chats

1. Mobile (i.e., wireless) user A @MIN (4102631111) would like to send an individual message to another member in the Chat community.
2. Using her phone, mobile user A sends a mobile originated message to ‘3428’ (CHAT) with body “@<alias> <message_content>.”
3. The content is sent to the IRC Server as a private message, where it is delivered only to the specified recipient. If the recipient happened to be a mobile user, then the message would arrive on the recipient's mobile device.

### Scenario B: Mobile User Creates/Initiates Participation in Chat Group

1. Mobile user A would like to participate in a chat group (#LB). They enter the command “#LB” to destination CHAT.
2. The SMSC 104 forwards the message to the mobile chat proxy server 100 for handling. If the group #LB was already created, then the mobile chat proxy server 100 adds mobile user A to the chat group and forwards messages sent to that chat group their way. If that chat group is not yet created, then that chat group is automatically created and they are added.

### Scenario C: Web Browser User Joins Chat Group and Requests Mobileuser's Participation.

1. Web browser user C would like to conduct a text based conversation within chat group #LB.
2. Using any IRC capable application, the web browser user C connects to the mobile chat proxy server 100, e.g., using the TCP/IP port 6700 (or other specified port).
3. Once connected to the conventional IRC Server 190, the user joins the #LB chat group.
4. The mobile chat proxy server 100 sends mobile user A a Reply Requested message asking them if they would like to engage in a chat with web browser user C at chat group #LB. If mobile user A accepts, then mobile user A is added to the LB chat group, thus allowing mobile user A and web browser user C to conduct a text based conversation.
5. If mobile user A rejects, then web browser user C is notified, but the #LB chat group continues to exist with web browser user C as a participant.
   Scenario D: Web Browser User Initiating Private Chat Only with a Mobile User.
1. Web browser user C wants to initiate a private chat only with mobile user A.
2. Web browser user C submits A's MIN, and their desire to conduct a private chat with mobile user A, to the mobile chat proxy server 100.
3. The mobile chat proxy server 100 creates a new chat group with web browser user C's name (or a unique derivative), and enters web browser user C into the newly created chat group.
4. The mobile chat proxy server 100 sends mobile user A a Reply Requested message asking for confirmation to participate in a private chat with web browser user C.
5. Mobile user A's response is shown to web browser user C.
6. If mobile user A accepts, mobile user A is added to the chat group and any outgoing messages to ‘CHAT’ from mobile user A will be sent to web browser user C.
7. If mobile user A is already in another chat group, then mobile user A must specify the destination of the message [#]group_name[*]message. Alternatively, the mobile chat proxy server 100 can prompt the mobile user A for the identity of the desired chat group.

The mobile chat proxy server 100 allows mobile users to be in multiple chat groups simultaneously. However, if so, the mobile user must identify the name of the chat group a particular message is destined for. If the mobile user does not identify the name of the chat group, the mobile chat proxy server 100 can send a message back to the mobile user requesting that they identify the name of the chat group for which the message is destined. The chat server can also be configured to limit users to joining only a single chat group at a time.

Upon joining a chat group, the mobile chat proxy server 100 can send a message to the mobile user notifying him/her the name of the chat group which they have joined, e.g., “You've joined group KB as 1234”. The administrator can disable this behavior by the chat server. Unless an alias has been provided, mobile users may be identified by, e.g., the last 4 digits in their MIN (or unique derivative).

The mobile user has the ability to create an alias. The alias may be in effect for the current chat session(s). A default alias may be used, e.g., if the mobile user has defined an alias through another web provisioning application. If so, the *ALIAS* command may be used to override the default alias for the duration of the chat session in that group. The administrator can disable the user alias feature.

The mobile user's MIN number may be made invisible if the mobile user wishes. However, for mobile device-to-mobile device chat group conversation, the MIN should be present to provide the required call back information.

Preferably, the mobile chat proxy server 100 can maintain statistics, e.g., regarding the number of chat messages sent/received by each MIN, just as the SMSC 104 typically does.

The mobile chat proxy server 100 is able to connect to multiple IRC Servers by simple changes in a configuration file. All operational parameters for the Chat Server are controlled through a configuration file.

Exemplary classes which can be implemented in accordance with the principles of the present invention are shown in the following table. Of course, these classes are for exemplary purposes only. Additional and/or alternative classes may be implemented within the scope of the present invention.

MESSAGE HANDLER CLASSES

Message Class
IRC Session Class
Mobile Command Decoder
Active Session Container
Chat Server
Mobile Sender
Mobile Receiver
MOChat Defined Exceptions

Preferably, the mobile chat proxy server 100 is implemented to function while sharing a link ID, either with the wireless Internet gateway 106 or on its own. Moreover, the mobile chat proxy server 100 is preferably able to identify incoming chat requests, and to differentiate from other incoming messages (e.g., Delivery Receipts and MOE-mail requests).

Based on a particular application, mobile users may be configured or otherwise controlled to not receive a copy of chat group messages that they've sent.

In the disclosed mobile chat proxy server 100, chat group messages to mobile devices may be limited to a predetermined number of characters, e.g., as defined by the administrator. Preferably, otherwise conventional gateway services, e.g., message truncation and linking, can be utilized.

FIG. 3 shows how the invention is able to support various types of clients for Chat services. The software allows other applications, such as web servers and WAP Servers, to enroll participants in Chat groups.

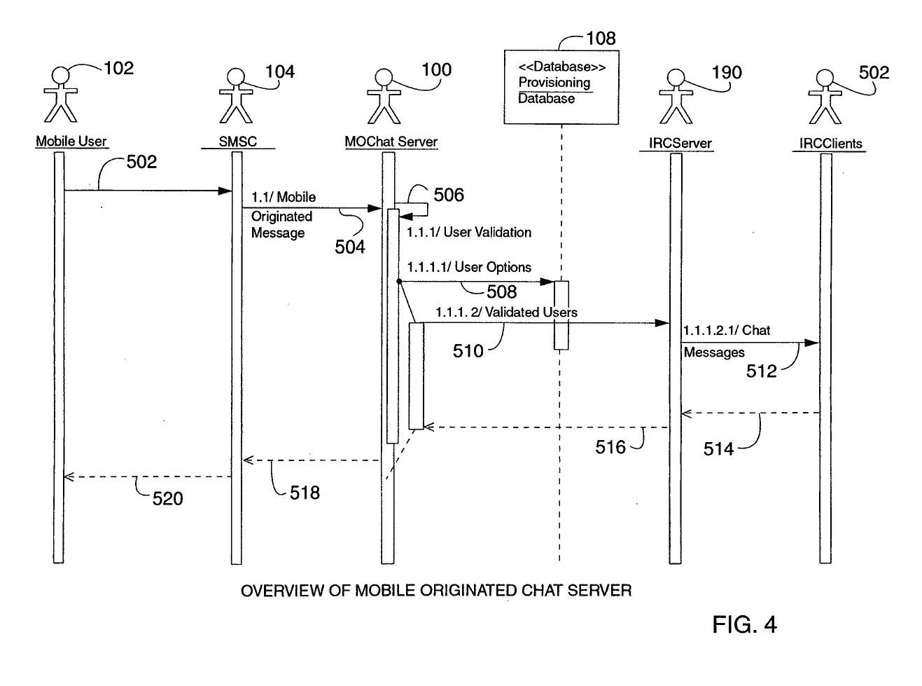

FIG. 4 shows an overview of the communications between the user of the mobile device 102, the short messaging system controller 104, the mobile chat proxy server 100, the database 108, the conventional IRC server 190, and IRC clients 502 participating in a chat group, in accordance with the principles of the present invention.

In particular, as shown in FIG. 4, Mobile originated Chat allows a mobile user 102 using a cell phone to start a chat group. The mobile user 102 generates a chat message 502, which is transmitted to the SMSC 104. The SMSC forwards the mobile originated message 504 to the mobile chat proxy server 100. The mobile chat proxy server 100 conducts user validation with message 506, user options with message 508, and allows validated users to enter the chat group of the conventional IRC server 190 with message 510. The mobile user's chat group messages are copied to all chat group participants (IRC clients) 502. Acknowledgements may be provided back from the IRC clients 502 to the conventional IRC server 190, to the mobile chat proxy server 100, to the SMSC 104, and to the mobile user 102.

On startup, the disclosed exemplary embodiment of a mobile chat proxy server 100 creates instances of the following primary objects for a ChatServer. These objects delegate to subclass and other objects for help.

| OBJECT | DESCRIPTION |
|---|---|
| MessageHandler | Queue Based Thread that will process and |
| | dispatch all messages entering system. |
| ConfirmationSessionContainer | Whenever the MessageHandeler |
| | encounters an in-complete or |
| | ambiguous handheld message it |
| | will be the task of this object to clarify |
| | the message with the user. Once the |
| | message has been clarified it will then |
| | be sent back to the MessageHandeler. |
| Logger | Process for logging errors/notices to a |
| | central location. Each top-level |
| | object created by the ChatServer |
| | will receive a reference to this |
| | object. This will be an instantiation of the |
| | Logger class defined in the WebGateway. |
| MessageSender | Abstract class which details the necessary |
| | methods anyone wishing to implement |
| | a new chat service must implement |
| | to integrate with MOChat seamlessly. |
| MobileReceiver | The object is responsible for receiving and |
| | disseminating all messages received from |
| | the SMSC. MobileReceiver implements |
| | the SMPPListener interface |
| | and communicates to the |
| | gateway using RMI. Upon creation |
| | MobileReceiver will create the |
| | MobileSender class. |
| MobileSender | Implements the MessageSender interface |
| | and is responsible for transmitting all |
| | messages to the SMSC. |
| Config | This object encapsulates all access to |
| | MOChat Configuration information. |
| MobileCommandDecoder | This class will parse and return requested |
| | parts of Mobile Command. All new |
| | mobile commands added to MOChat |
| | must be implemented here. |
| WebProvisionInfo | Returns requested information from the |
| | Web Proivisioning database about a |
| | user when given a MIN. |
| Message | Primarily a data class that encapsulates all |
| | information about MOChat messages in |
| | system. Class also has the ability to |
| | read/save properties to an XML document. |
| ReplyRequestMessage | Subclass of Message. Used when sending |
| | reply requested messages to mobile user |
| | for Confirmation. |
| IRCSession | The IRCSession is a mini IRC Client. It |
| | encapsulates all conversations between the |
| | user and the IRC Server. |

The Config class will load the configurable parameters from a properties file, e.g., a “MOCHAT.properties” file. Preferably, the mobile chat proxy server 100 will be configurable through user options. In the disclosed embodiment, configuration information may be retrieved using the Config object class.

### Exemplary Format of Mobile Commands

Transactions from cell phones may be initiated by sending a mobile originated (MO) message to address 3428 (CHAT) with the following format options:

| Join a group | #<Group ID> |
|---|---|
| To join all pre-defined favorite Chat | J* |
| Groups. A Web interface allows users to | |
| define their favorite groups | |
| Send a message: | |
| If only in one group | <message> |
| If in multiple groups | #<Group ID> <message> |
| Assign an alias | A*<new alias> |
| Summon another mobile user to join | S*<MIN> |
| Obtain information about groups: | |
| Which groups user has joined | I* |
| Who is in a group | I*<Group ID> |
| Prevent announcements from being | H* |
| made when joining/exiting groups | |
| Exit Chat | |
| To exit all groups | B* |
| To exit a particular Chat Group | B*<Group Id> |
| Ghost chat messages to a MT device. | G*<MIN> |
| To support MT devices, ghost requests | |
| can be sent from a web page or | |
| WAP/UP browser. | |

### Top Level Processing Logic for Mobile Chat Proxy Server

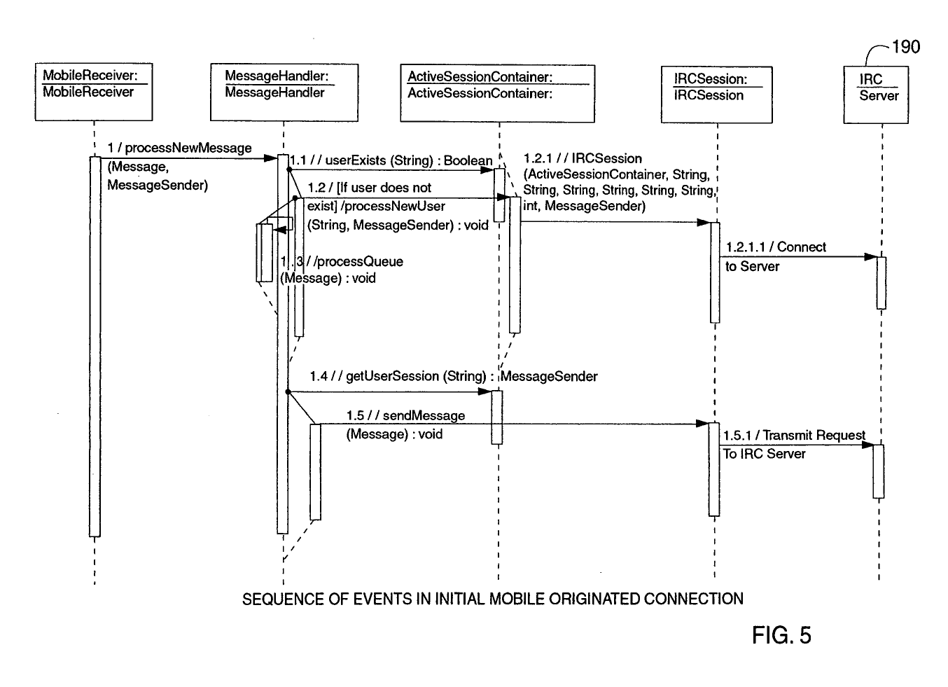

FIG. 5 shows an exemplary top level sequence of events in an initial mobile originated connection using a mobile chat proxy server, in accordance with the principles of the present invention.

Of particular note in FIG. 5, the IRemoteSMPPProxy process forwards the message to the MobileReceiver's receiveMessage method. This method will ensure that that the message is a mobile originated message. If it's a valid mobile originated message (i.e., not a delivery/read receipt, etc.), then the chat message is added to the MessageHandler's queue.

At that point, it is the job of the MessageHandler in conjunction with the ActiveSessionContainer to instantiated an instance of the IRCSession class to provide the services required by that mobile user.

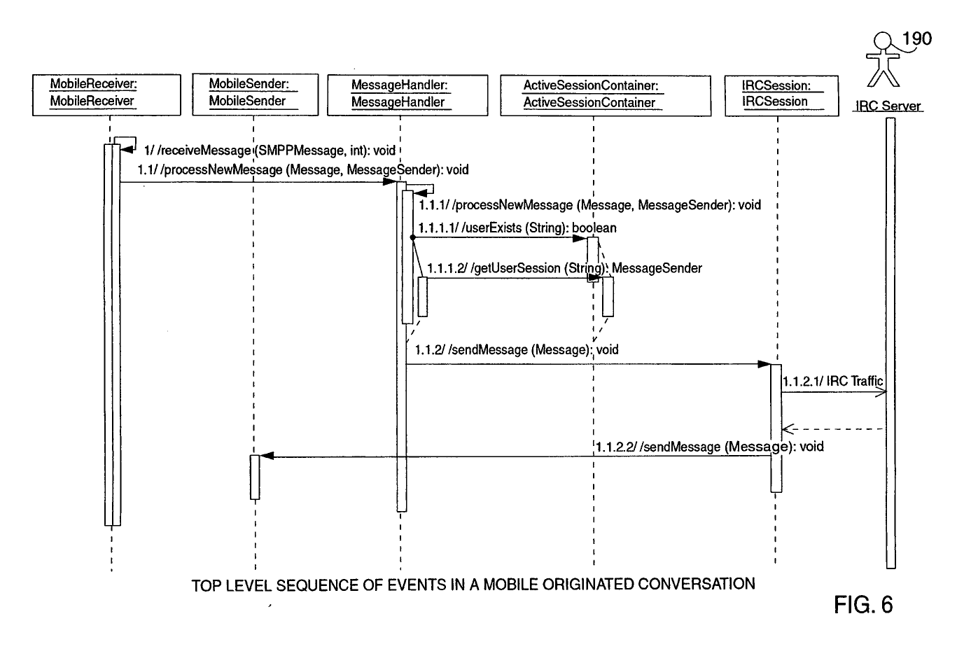

FIG. 6 shows an exemplary top level sequence of events in a mobile originated conversation using a mobile chat proxy server, in accordance with the principles of the present invention.

In particular, as shown in FIG. 6, the IRemoteSMPPProxy process forwards the message to the MobileReceiver's receiveMessage method. This method ensures that that the message is a mobile originated message. If it's a valid mobile originated mMessage (i.e., not a delivery/read receipt, etc.), then the message is added to the MessageHandler's queue. The MessageHandler class in conjunction with the ActiveSessionContainer delivers the message to the users personal IRCSession for handling a sequence of events for an improperly formatted mobile originated message.

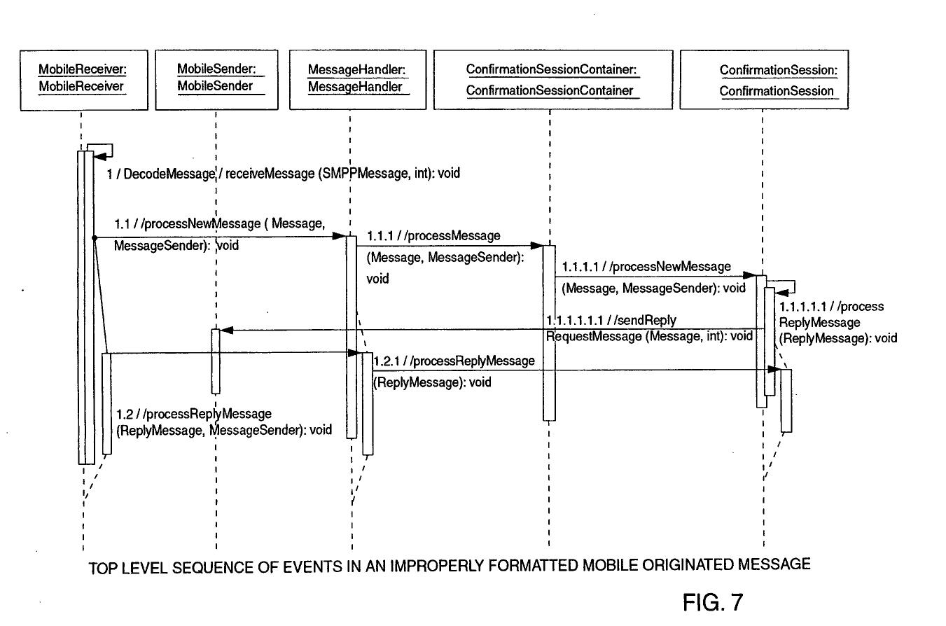

FIG. 7 shows an exemplary top level sequence of events for an improperly formatted mobile originated message using a mobile chat proxy server, in accordance with the principles of the present invention.

In particular, as shown in FIG. 7, an exemplary sequence of events for handling an improperly formatted message may be very similar to those of a mobile originated conversation as shown in FIG. 6. However, one difference in processing occurs when the MessageHandler processes the message. If the MessageHandeler is unable to accurately deliver the message, it transfers processing of the message to a ConfirmationSession. It is the responsibility of the ConfirmationSession to query the user for help in the appropriate processing of the message. The message will be discarded if the ConfirmationSession is unable to correct the message in a system defined time period.

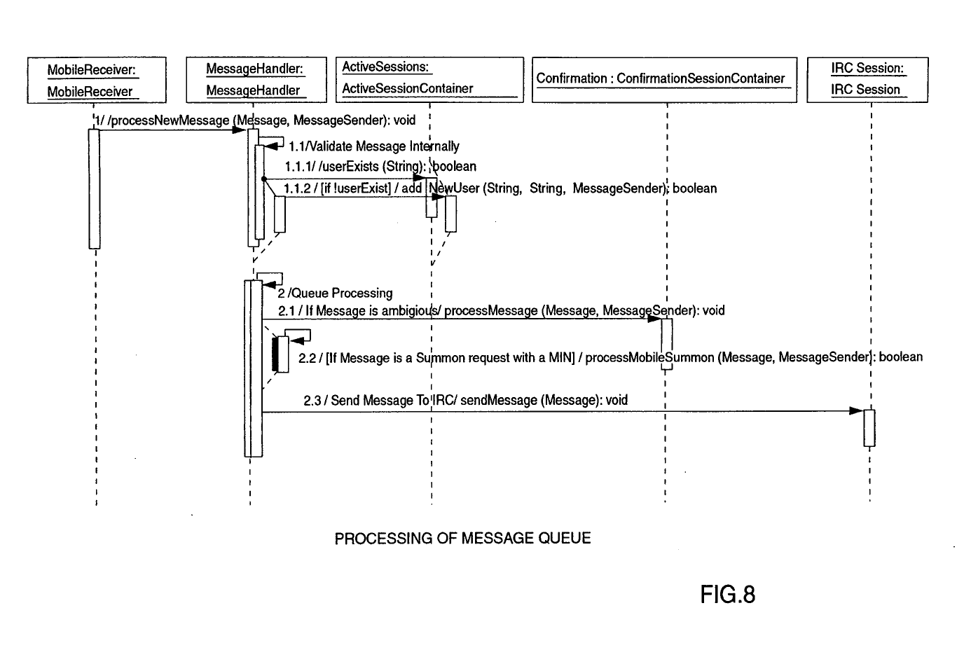

FIG. 8 shows an exemplary processing of a message queue of a mobile chat proxy server, in accordance with the principles of the present invention.

In particular, as shown in FIG. 8, the MessageHandler is responsible for dispatching messages to the individual IRCSession or chat source.

In theMessageHandler, once a message has been validated, it is added to the internal message queue 310. The processQueue method of the MessageHandler checks the thread periodically (e.g., every x milliseconds) or when notified of a new item. The method processQueue dispatches the message to the appropriate recipient.

In the disclosed embodiment, the message queue 310 is a first-in, first-out (FIFO) type queue. Preferably, in the message queue 310, if the message is ambiguous, it is preferably dispatched to the ConfirmationSession Container for further processing. If the message is a SUMMON with the recipient ID indicating a mobile number, then a summon SMS message will be sent to the recipient. If the message proceeds through the ambiguity test and the SUMMON test, then it will be sent to the sender's IRCSession for further handling.

In the disclosed embodiment, the MobileSummon executes within the same thread as the processQueue, but this need not necessarily be the case.

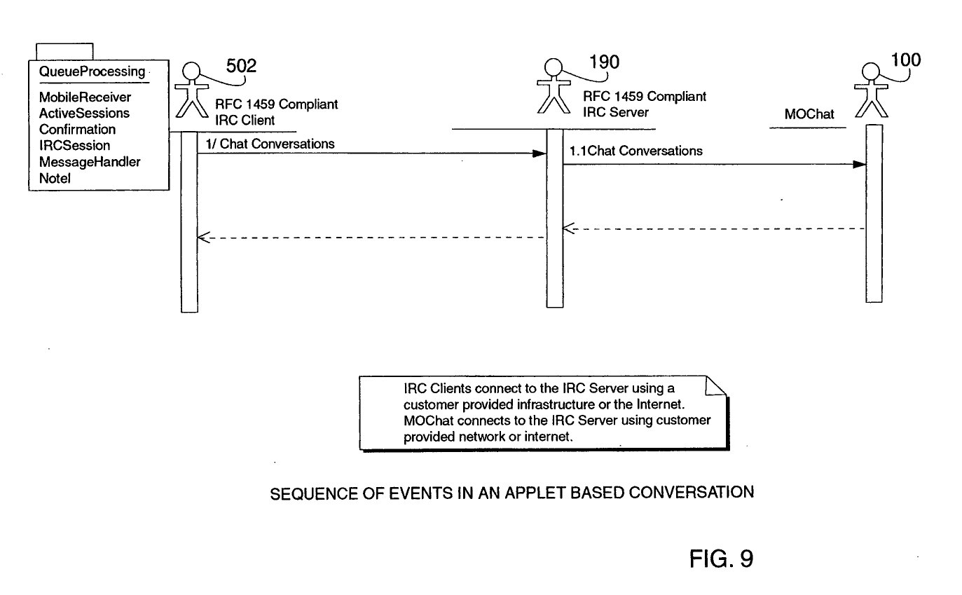

FIG. 9 shows an exemplary sequence of events in an Applet-based conversation, in accordance with the principles of the present invention.

In particular, as shown in FIG. 9, IRC clients (i.e., chat group participants) may connect to the conventional IRC server 190 using a conventional IRC chat group infrastructure or the Internet. Mobile users 102 may connect to the conventional IRC server 190 using a network or Internet connection including a mobile chat proxy server 100 in accordance with the principles of the present invention.

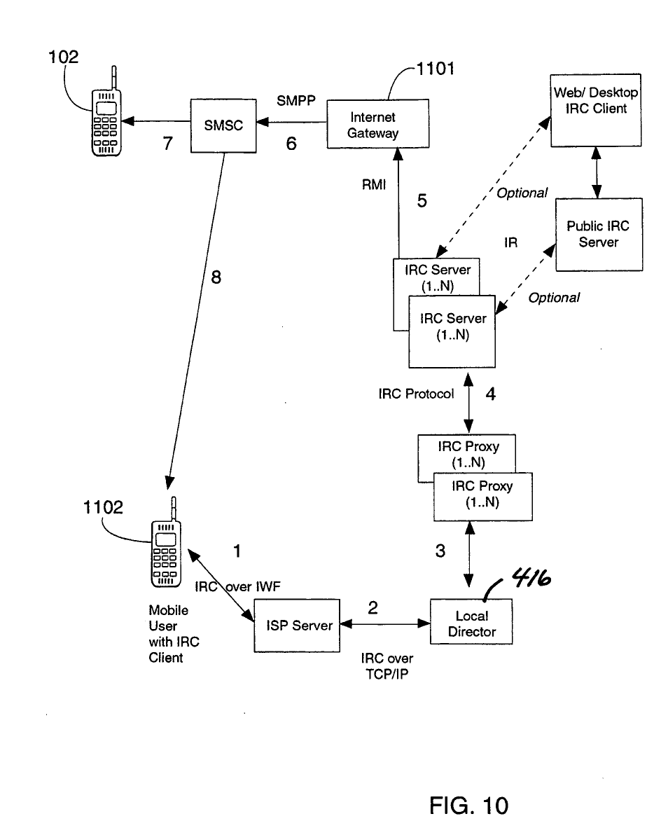

The invention also supports mobile handsets that are natively running an IRC client. IN this case, the handset does not communicate through the SMSC but directly interacts with the chat server. FIG. 10 illustrates the components of an IRC chat group solution allowing IRC-enabled mobile handsets 102 to participate in IRC chat groups using an Interworking Function (IWF) connection (in place of the SMPP connection shown in FIG. 1), in accordance with the principles of the present invention.

The IRC chat group solution using an IWF connection as shown in FIG. 10 includes specialized IRC servers, a Local Director 416, and customer-provided IRC chat clients. The IRC Servers support the IRC protocol as defined by RFC 1459 and as enhanced for Unicode support through the 1998 Microsoft draft IRCX proposal. Any IRC client is able to attach to the chat solution. Mobile clients do not attach directly to an IRC server. Rather, clients attach to a single virtual server as represented by the Local Director. The Local Director load-balances the traffic across multiple IRC proxy servers. Proxy servers perform special actions that are applicable for mobile users, such as sending notices via SMS to users who are not connected to the chat server. If any proxy server becomes unavailable, then the Local Director automatically removes it from the pool of available servers. The Local Director will also automatically re-add servers that later become accessible. Interoperation between multiple servers is defined by the IRC specification.

An IRC software module in the mobile user handset 102 allows mobile users to participate in chat sessions. This IRC software module is configured to automatically connect via IWF to a specified number. Customer provided ‘ISP hardware’ such as the Ascend TNT can convert traffic from the destination modem to a direct TCP/IP connection to the Local Director. Once a connection is established, the phone appears as any standard IRC client.

FIG. 11 shows an initial connection to the IRC server shown in FIG. 10, in accordance with the principles of the present invention.

In particular, when the mobile user 102 initially connects, the IRC Proxy will validate whether that user has access to the specified service. Thus, user access to packet and e-chat services may be validated against the customer database 108 upon initial connection of that mobile user 102.

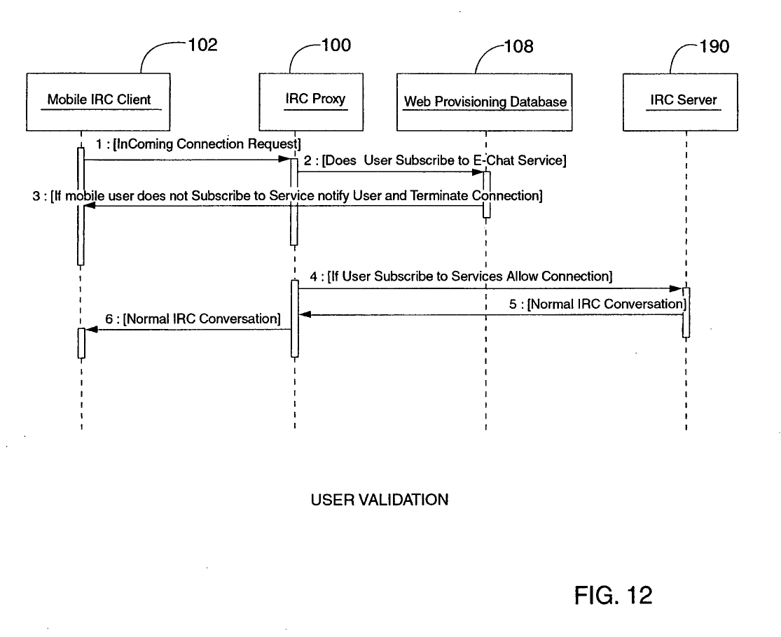

FIG. 12 is a detailed process flow showing the validation of the mobile user 102 in the mobile chat system shown in FIG. 11.

In particular, as shown in FIG. 12, the mobile chat proxy server 100 queries the provisioning database 108 for the access rights of the currently connected mobile user 102. If that mobile user 102 has access to the specified resources, then a connection to the conventional IRC server 190 will be initiated. Otherwise, the mobile user 102 may be informed of the reason for their denial via the mobile chat proxy server 100. Password validation can also be provided at this point.

After validating the mobile user 102, the mobile chat proxy server 100 will forward all IRC traffic from the mobile user 102 to the conventional IRC server 190, after examination of all IRC commands for the mobile specific implementation.

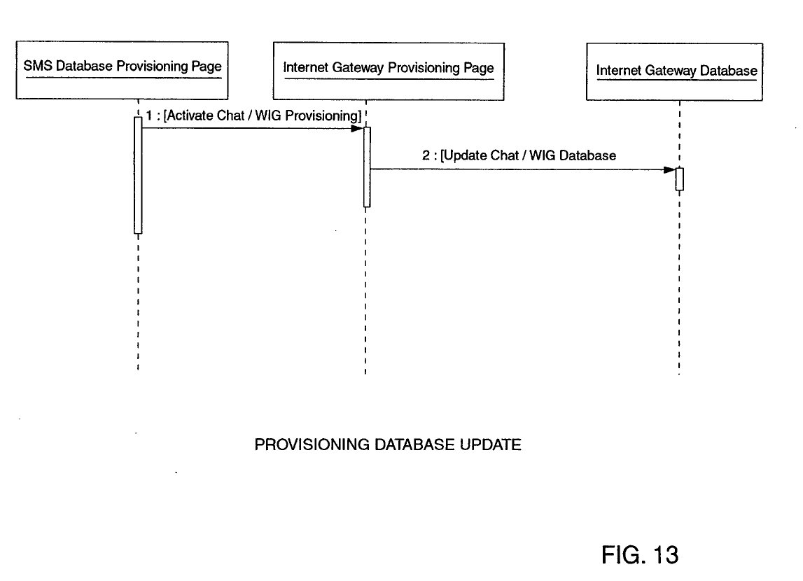

FIG. 13 shows an update of the provisioning database in the system of FIG. 10, in accordance with the principles of the present invention.

In particular, short messaging system (SMS) administrators may be presented with an appropriate web page or web page link to connect them to the provisioning database of the Internet gateway 1101 (FIG. 10). From such a web page, the administrator may update relevant user information regarding chat group use.

For instance, administrators may assign chat privileges to subscribers by accessing a custom link in the SMS web interface. This link may activate a preformatted form for assigning chat access to a particular MIN.

SMS special enhancements may be implemented to the IRC to enhance the mobile-user's experience.

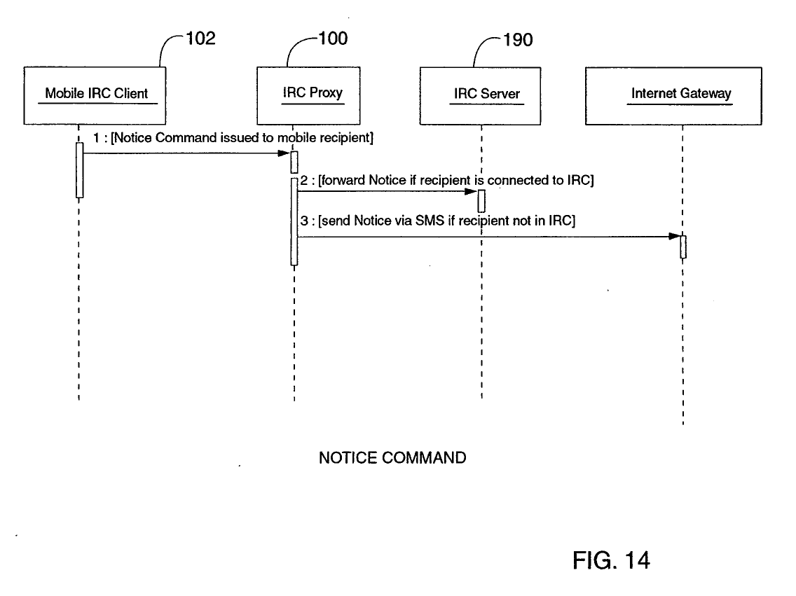

For instance, FIG. 14 shows an exemplary process of an IRC “Notice” command, in accordance with the principles of the present invention.

In particular, the IRC “Notice” command may be used to initiate SMS messages to mobile handset users. This IRC “Notice” command may be used, e.g., to broadcast a message across multiple groups in an attempt to reach the destination party.

In one implementation, the mobile chat proxy server 100 will determine if the destination address for the Notice command is a MIN. If so, the Notice may be sent via the SMS to the mobile handset by way of the wireless Internet gateway 106. The wireless Internet gateway 106 can ensure that the message is successfully delivered to the mobile handset. If the Notice destination is not a MIN, then it is handled normally.

IRC allows a user to issue commands. In the disclosed embodiment, example Notice commands to transmit a message to an identified user may be formatted as:

NOTICE <user> <message>; and

PRIVMSG <user> <message>

The mobile chat proxy server 100 may enable these commands by using the SMS to notify the mobile recipient of messages directed to them.

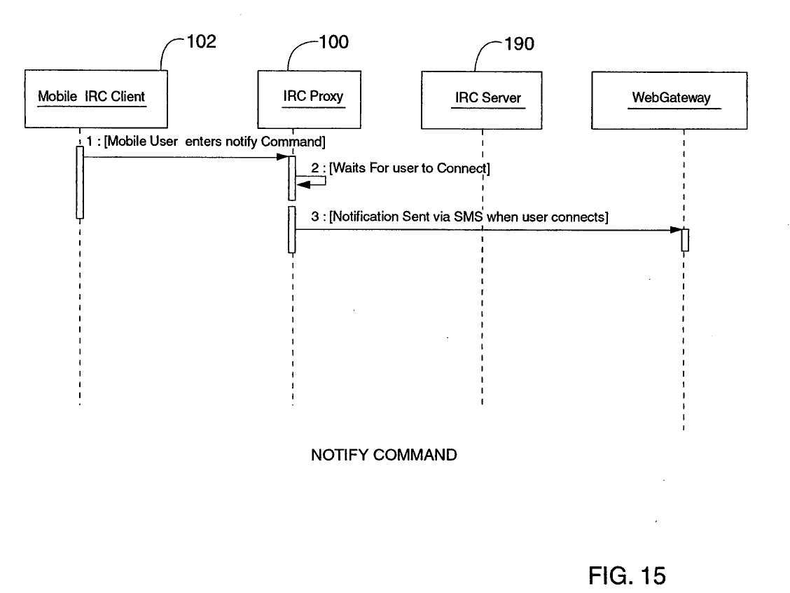

FIG. 15 shows an exemplary IRC “Notify” command having special properties for an SMS, in accordance with the principles of the present invention.

In particular, as shown in FIG. 15, a NOTIFY <user> command allows a mobile user to request notification from the SMS when a specified user connects. When the user connects, an SMS message is sent to the requesting user identifying the connected user and channel. This ‘buddy list’ notification allows any of the devices connected to the chat server to be notified of other users when they are available.

With the Notify command, a mobile user can request to be notified when another user accesses the conventional IRC server 190. Mobile users can utilize this feature by having SMS messages delivered to them when another user logs onto the conventional IRC server 190. In this way, mobile users can be notified when their friends are ready to chat.

Preferably, notification requests remain active for only a specified period of time on the server.

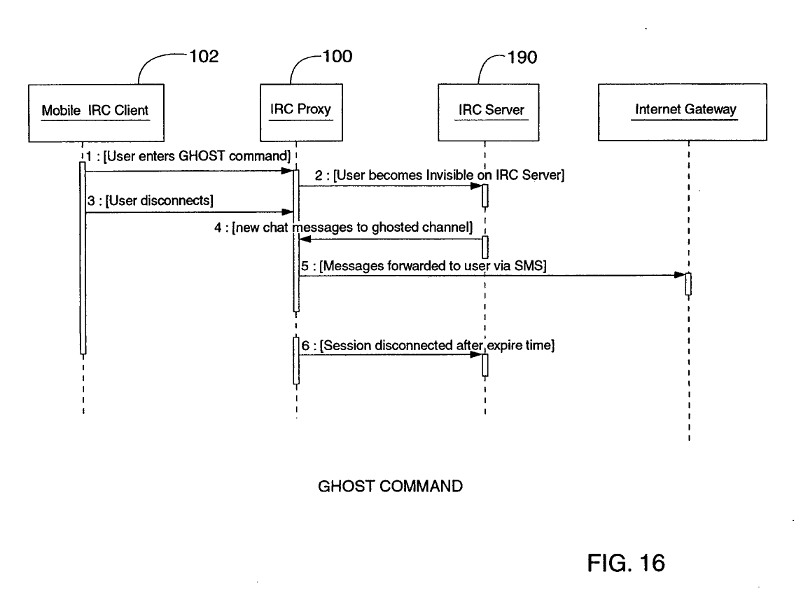

FIG. 16 shows a special “Ghost” command to enable a user to monitor an IRC chat group (or channel) via the short message service (SMS) without maintaining a connection to the conventional IRC server 190, in accordance with the principles of the present invention.

In particular, the Ghost command may be considered to be equivalent to the IRC “mode +i” command, as it is an IRC proxy implementation of the IRC “mode +i” command. Specifically, the user enters the “GHOST” command and disconnects from the conventional IRC server 190. Once disconnected, the mobile chat proxy server 100 will forward all messages received in the chat group (or channel) to the user via SMS messages through the wireless Internet gateway 106. This forwarding may be performed as long as desired, e.g., for a pre-configured, authorized, requested, or other period of time. The period of time may be system dependent.

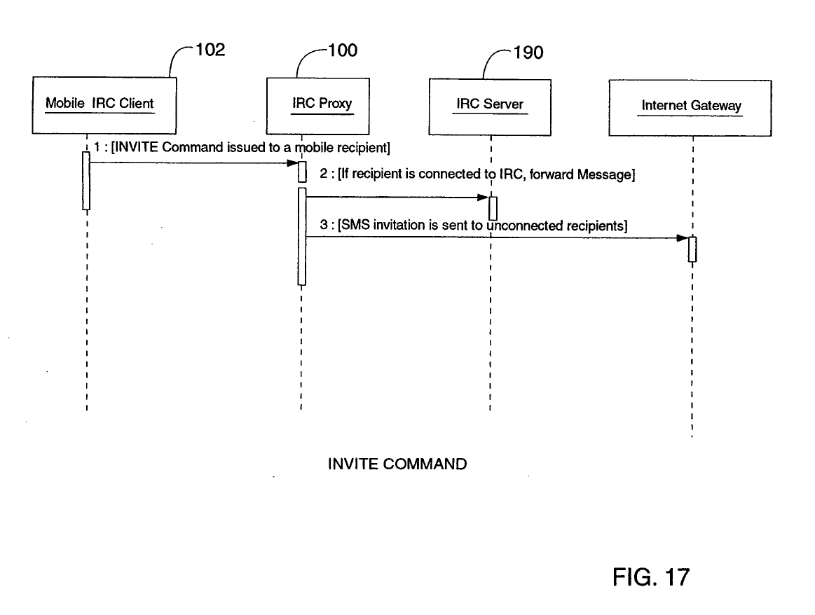

FIG. 17 shows the implementation of a special IRC “Invite” command to provide the mobile user with the opportunity to use SMS to extend chat invitations to other mobile users, in accordance with the principles of the present invention.

In particular, as shown in FIG. 17, IRC protocols allow a user to issue the commands NOTICE <user> <message> and PRIVMSG <user> <message> to transmit a chat message to an identified user. In accordance with the principles of the present invention, the mobile chat proxy server 100 may enhance these commands with an INVITE command. Using the INVITE command, the mobile chat proxy server 100 uses the short message service (SMS) to notify mobile users of messages directed to them.

With the “Invite” command, the mobile user can request that the mobile chat proxy server 100 notify the specified user of a request to chat via SMS messaging. If the destination user is currently connected to IRC, they may be notified using the IRC protocol.

Preferably, a mobile chat proxy server 100 in accordance with the principles of the present invention supports the core messaging features of conventional IRC protocol as defined in RFC 1459 and as enhanced for Unicode support in the 1998 Draft IRCX specification by Microsoft. In accordance with the principles of the present invention, mobile devices (e.g., mobile handsets) desiring to lurk in a chat group, or participate in a chat group, include a native IRC client application which supports the IRC specification as defined in RFC 1459 and supporting Unicode as defined in, e.g., Microsoft Corporation's draft specification.

Preferably, the native IRC client application in the mobile device maintains a constant connection to the conventional IRC server 190 via the mobile chat proxy server 100 using the IWF for the duration of the chat session, during which time native IRC commands may be exchanged between the mobile user client and the conventional IRC server 190 as interpreted by the intervening mobile chat proxy server 100.

Preferably, a TCP/IP socket connection will be established between the terminating IWF modem and the mobile chat proxy server 100. The conventional IRC server 190 preferably has TCP/IP access to the wireless Internet gateway 106 for delivering short message system messages. The mobile handsets and the IRC client software in the conventional IRC server 190 will properly establish an IWF connection when an SMS message with appropriate callback is received and the user presses ‘talk’. A full-time Internet connection may be made available if Internet-based IRC clients will be accessing the mobile chat proxy server 100.

The invention has applicability for use by, e.g., wireless carriers, and as a portal site for mobile-terminated ghosting of chat groups.

While the invention has been described with reference to the exemplary embodiments thereof, those skilled in the art will be able to make various modifications to the described embodiments of the invention without departing from the true spirit and scope of the invention.

1. A method of providing access to a channel of an Internet Relay Chat group to a mobile device, comprising:
placing a mobile chat proxy server in a communication path between a standard Internet Relay Chat server and a wireless gateway server supporting said mobile device;
wherein said mobile chat proxy server forwards chat commands from said mobile device to said standard Internet Relay Chat server.

2-38. (canceled)
